(19) United States
(12) Patent Application Publication
(10) Pub. No.: US 2026/0369435 A1
(43) Pub. Date: Nov. 19, 2026

(54) A MOLTEN SALT NUCLEAR REACTOR WITH GAS SYSTEM AND METHOD OF OPERATING SUCH A REACTOR

(71) Applicant: Copenhagen Atomics A/S, Kastrup (DK)

(72) Inventor: Aslak STUBSGAARD, Copenhagen K (DK)

(73) Assignee: Copenhagen Atomics A/S, Kastrup (DK)

(21) Appl. No.: 19/475,196

(22) PCT Filed: Apr. 19, 2024
(86) PCT No.: PCT/DK2024/050093

§ 371 Date: Oct. 14, 2025

(30) Foreign Application Priority Data
Apr. 21, 2023 (DK) PA202370188

(51) Int. Cl. G21C 3/54; G21C 19/303; G21F 9/02

(52) U.S. Cl. CPC G21C 3/54; G21C 19/303; G21F 9/02

(57) ABSTRACT

A molten salt nuclear reactor and method of operating such a reactor. The molten salt reactor comprises a closed and leaktight vessel (1,40) containing at least one molten salt loop (3,13), and a gas system for receiving gas originating from the at least one molten salt loop (3,13), the gas system comprises at least one gas-holder (30,34) of variable capacity configured for holding gas originating from the molten salt loop (3,13).

### TECHNICAL FIELD

The disclosure relates to a gas system for a molten salt nuclear reactor that handles off-gas and/or cover gas, and to a molten salt nuclear reactor with such a gas system.

### BACKGROUND

Molten salt nuclear reactors offer unique advantages over conventional nuclear reactors, one of the primary benefits is that their fuel is a liquid at operating temperature. Some of the advantages of having a liquid fuel are:
higher thermal expansion coefficient of molten salts when compared to solid fuel, leading to more negative reactivity feedback,
the possibility of passively removing the fuel from the core for decay heat removal,
the possibility of changing the composition of the fuel while operating, e.g. fission product removal, and
the ability of noble gasses and volatile fission product compounds to evaporate out of the fuel salt which is a great benefit to reactor stability since the largest fission product poison is the noble gas isotope xenon-135 with a half-life of 9 hours.

Noble gasses, tritium, salt mist, salt vapors, and volatile fission product compounds that are released from the fuel salt are collectively referred to as off-gasses and the action of them releasing from the salt is referred to as off-gassing. Often a gas phase of inert gas, such as helium or argon, is used as a cover gas over the fuel salt to capture, treat, and store or release the off-gasses. Argon as a cover gas has the disadvantage that it becomes neutron activated with a half-life of 110 minutes, while helium practically does not become neutron activated but is more costly than argon and has a limited supply. An intermittent or continuous cycle of cover gas entering and off-gas leaving the reactor poses a contamination risk to the salt and a radionuclide release risk, respectively.

A molten salt reactor can contain several molten salts, such as a fuel salt containing fissile material, a coolant salt to transfer the heat from the fuel salt to a tertiary system, a blanket salt containing fertile material to produce new fissile material from the excess neutrons, and scrubber salt that captures off-gasses from a fuel salt or contains separated fission products from the fuel salt. Usually, the different molten salts contained in a molten salt reactor will have separate cover gas and off-gas systems. These cover gas and off-gas systems must take into account several aspects, such as the chemical species encountered in the gas phase, the thermal expansion of the cover gas when heating and cooling, and the heat generated from radioactive decay.

The off-gas from a fuel salt is highly radioactive and mobile due to being a gas and can thus constitute a major radionuclide release risk. The handling of molten salt cover gas and off-gas is thus a very significant element of molten salt reactor operations and therefore the commercialization and deployment of molten salt reactors.

Several molten salt cover gas and off-gas handling solutions have been proposed for molten salt reactors. Broadly there are three types of proposed methods to deal with the off-gas of a molten salt reactor: containing the gas in a fixed volume, purging fresh cover gas through the reactor and discharging off-gas, or purging recycled off-gas through the reactor. These three types of solutions can of course also be used in conjunction.

In one type off-gas is stored in a pressurized tank or series of pressurized tanks, pressurized with compressors, until the activity is safe for release. In one type the off-gas flows through filters and scrubbers that capture certain radioactive elements, including noble gasses, making the remaining gas stream leaving the filters and scrubbers safe for release. The molten salt reactor experiment (MSRE), that ran in the 1960's also used a series of filters before releasing the scrubbed helium gas out of a chimney stack. In one type the off-gas flows through a system of tanks or labyrinths with a retention period long enough to reduce the activity far enough through natural radioactive decay to allow the off-gas to be released, possibly in conjunction with filters or scrubbers.

Filters could e.g. be mechanical filters such as HEPA filters, sintered metal filters, or chemical filters such as charcoal or activated carbon filters.

Scrubbers could e.g. be freeze traps, cryogenic freeze traps, reactants such as hydroxides, molten salts, water, or metal-organic frameworks for retaining noble gasses.

The use of closed and pressurized off-gas systems has the disadvantage of an increased risk of rupture and radionuclide release. The failure of a pressured off-gas system can also cause other reactor vessels or systems to be pressurized that are not designed to such pressures, constituting an increased risk or design complexity.

The use of a continuous purge of cover gas systems has the disadvantage that they need penetrations through protective boundaries around the reactor which constitute a major risk of radionuclide release in case of an accident and a possible attack vector for adversaries. Furthermore, if the gas system needs a constant flow of cover gas through the system then the gas supply can be a source of contamination from e.g. oxide, moisture, or hydrocarbons. The cover gas supply, be it in the form of cryogenic dewars, pressurized gas bottles, or a gas generator, constitutes additional complexity and risk to a molten salt reactor. The off-gas can also contain chemical compounds, such as halogen gasses, that can pose a chemical hazard if released, either produced as part of normal operation or produced in an accident scenario.

In WO2021234045A1 the fuel salt is contained in tubes and in one embodiment the gas is connected to a cover gas system and in another embodiment, the gas is confined in the tube and allowed to pressurize the tube.

ORNL/TM-2019/1266 gives a review of off-gas systems for molten salt reactors, describing a system of scrubbers and filters to recirculate a molten salt reactor off-gas back into the reactor. this design is based on the system envisaged in ORNL-4541 of an off-gas system for a conceptual design study of a single-fluid molten-salt breeder reactor. WO2017030107A1 discloses a molten salt nuclear reactor according to the preamble of claim 1 and a method according to the preamble of claim 18.

### SUMMARY

It is an object to provide a gas system for a molten salt nuclear reactor and a nuclear reactor with such a gas system that overcomes or at least alleviates the above-mentioned problems.

The foregoing and other objects are achieved by the features of the independent claims. Further implementation forms are apparent from the dependent claims, the description, and the figures.

According to a first aspect, there is provided a molten salt nuclear reactor comprising:
a closed and leak-tight vessel containing:
at least one molten salt loop and
a gas system for receiving gas originating from the at least one molten salt loop,
the gas system comprising at least one gas-holder of variable capacity configured for holding gas originating from the molten salt loop.

This molten salt reactor gas system allows for molten salt reactor components such as salt tanks and reactor vessels to be non-pressurized, instead allowing for the equalization of pressure through gas-holders to an external closed and leak-tight containment structure and can be a completely sealed system lowering the gas system complexity and risk of radionuclide release. Furthermore, the system neither needs a constant supply of cover gas nor a continuous treatment of the off-gas.

According to a possible implementation form of the first aspect, the at least one gas-holder of variable capacity is a low-pressure gas-holder of variable capacity, and/or the pressure around the at least one gas-holder of variable capacity is substantially equal to or slightly below ambient pressure outside the containment structure, and/or the pressure in the gas system is equal to or slightly above the pressure surrounding the at least one gas-holder of variable capacity.

According to a possible implementation form of the first aspect, a gas-holder of variable capacity is a gas-holder that has a variable capacity volume for storing gas.

According to a possible implementation form of the first aspect, the at least one molten salt loop comprises fissile material that generates off-gas, wherein the at least one gas-holder of variable capacity is dimensioned to hold the off-gas generated by the fissile material, preferably dimensioned to hold the off-gas generated during the lifespan of the fissile material or during the lifespan of the molten salt nuclear reactor.

According to a possible implementation form of the first aspect, the gas system is configured to contain a cover gas when the molten salt nuclear reactor is started up for the first time.

According to a possible implementation form of the first aspect, the at least one gas-holder of variable capacity has a first internal volume when the molten salt nuclear reactor is started up for the first time and has a second internal volume when the molten salt nuclear reactor is decommissioned, the second internal volume being larger than the first internal volume.

According to a possible implementation form of the first aspect, the difference between the second internal volume and the first internal volume is sufficient for accommodating the off-gas generated in the period between the initial start-up of the molten salt nuclear reactor and decommissioning of the molten salt nuclear reactor, at a pressure that is slightly higher than the pressure surrounding the at least one gas-holder of variable capacity.

According to a possible implementation form of the first aspect, the gas system is a closed system that fluidically only connects to the at least one molten salt loop.

According to a possible implementation form of the first aspect, the gas-holder of variable capacity comprises telescopically parts and/or comprises flexible walls for allowing expansion of the primary gas-holder of variable capacity, preferably without a significant increase of the pressure in the gas-holder of variable capacity.

According to a possible implementation form of the first aspect, the gas-holder of variable capacity comprises an expandable balloon or bladder for allowing expansion of the primary gas-holder of variable capacity, preferably without a significant increase of the pressure in the gas-holder of variable capacity.

According to a possible implementation form of the first aspect, the gas-holder of variable capacity comprises a piston with a leak-tight movable piston head and seal for allowing expansion of the primary gas-holder of variable capacity, preferably without a significant increase of the pressure in the gas-holder of variable capacity.

According to a possible implementation form of the first aspect, the gas-holder of variable capacity comprises one or more movable pistons and/or telescopically parts and/or comprises flexible walls and/or a bladder for allowing expansion of the primary gas-holder of variable capacity, preferably without significant increase of the pressure in the gas-holder of variable capacity.

According to a possible implementation form of the first aspect, the gas-holder is connected to a scrubber salt cover gas which in turn is connected to a fuel salt cover gas, where the scrubber salt is kept at a lower temperature than the fuel salt lowering volatile fission product vapor pressures or containing a reactive compound binding volatile species to the salt, such that the scrubber salt captures most of the volatile fission products, salt mist, salt vapor, or nongaseous species which is not desired to be in the gas-holder and lowering the heat load from radioactive decay on the gas-holder.

According to a possible implementation form of the first aspect the molten salt nuclear reactor comprises a containment structure containing:
the reactor vessel containing the gas-holder of variable capacity forming a primary gas-holder of variable capacity, and
a gas-holder containment structure containing a secondary gas-holder of variable capacity, the secondary gas-holder of variable capacity being fluidically connected to the interior of the reactor vessel and preferably being a low-pressure gas-holder.

According to a possible implementation form of the first aspect, the secondary gas-holder variable capacity is configured to receive gas from the reactor vessel, the temperature in the gas-holder containment structure preferably being lower than the temperature in the reactor vessel, thereby allowing the gas received from the reactor to cool down and take up less space.

According to a possible implementation form of the first aspect, the reactor vessel is divided into a hot and a cold area, and wherein the at least one primary gas-holder of variable capacity is arranged in the hot area and the secondary gas-holder of variable capacity is arranged in the cold area.

According to a possible implementation form of the first aspect, the reactor vessel is divided into a hot and a cold area, and wherein the at least one primary gas-holder of variable capacity is arranged in the cold area such that the hot expanding gas is contracted in the cold primary gas holder, lowering the total amount of cover gas/off-gas volume when compared to the primary gas-holder of variable capacity being arranged in the hot area.

According to a possible implementation form of the first aspect, the reactor vessel is divided into a hot and a cold area, and wherein the at least one primary gas-holder of variable capacity is arranged the cold area such that volatile salt species, such as volatile fission product species such as MoF6 and Csl, will condense in the cold region.

According to a possible implementation form of the first aspect, the reactor vessel is provided with a gas-holder of variable capacity that allows for the volume to expand and equalize its pressure with the pressure of the cover gas inside the containment structure and each salt loop is provided with a gas-holder inside the reactor vessel that allows for its volume to expand and equalize its pressure with the pressure of the cover gas inside the reactor vessel. In this way, there are several barriers for off-gas release first the salt bladder, then the reactor vessel bladder, and finally, the containment structure, and only the last barrier is potentially a pressure barrier. furthermore, in this way neither the salt tanks or the reactor vessel has to be a pressure vessel, lowering their complexity and cost.

According to a possible implementation form of the first aspect, the gas-holder of variable capacity are nested in each other to provide additional barriers to radionuclide release.

According to a possible implementation form of the first aspect, the gas-holders of variable capacity are nested in each other to provide additional barriers to radionuclide release, and the last barrier is not contained in a pressure vessel but instead in pressure equilibrium with the atmosphere and none of the cover-gas systems are pressurized.

According to a possible implementation form of the first aspect, the gas-holder of variable capacity are made up of a plurality of gas-holders of variable capacity connected in series or parallel, and potentially circulated by a blower, to provide a longer retention time for radionuclides to undergo radioactive decay before returning to the free surface of the salt. According to a possible implementation form of the first aspect, the molten salt nuclear reactor comprises a filter, trap, or scrubber, for removing e.g. volatile compounds and/or salt vapor, reactive species, tritium, which could potentially migrate through the gas-holder wall material, particulate matter, such as salt mist particles, or impurities such as oxygen, carbon dioxide, or moisture.

According to a possible implementation form of the first aspect, the gas-holder of variable capacity contains an absorber or reactants to react or bind species of off-gasses. Examples of these species of off-gases are tritium or volatile fission product compounds, gas species or elements that decay to other elements inside the bladder, halogen released e.g. from volatile fission product compounds that decay to noble gasses or elements with results in the release of halogen or e.g. the from the decay of cesium in volatile cesium iodide releasing iodine, or impurities such as oxygen, carbon dioxide, or moisture. An example of such an absorber could be reactive metals such as Mg or Ca metal, which will bind tritium as a hydride, halogens, such as metal halogens (e.g. MgF2) and oxides, such as metal oxides (e.g. MgO). Another example of these species are halogen gasses produced from the radiolysis of salts when solidified, where they are much less likely to recombine and form salt, and instead can migrate to the cover gas and to the gas-holder. This can lead to significant highly reactive gas buildup if the salt is left in a solidified state for an extended period with a large amount of radioactive decay in the salt, from e.g. fission products, activation products, or transmutation products. Thus, reactants that bind these halogen gasses can significantly reduce the risk of a radionuclide release in cases where the salt is left in the solidified state for a long time after shutdown, e.g. in the case of an accident that makes it hard to access the nuclear reactor.

According to a possible implementation form of the first aspect, the gas-holder of variable capacity is connected to a circulation pump or blower to allow for the gas to be recirculated between the salt containment and the gas-holder.

According to a second aspect, there is provided a method of operating a molten salt nuclear reactor arranged in a containment structure, the containment structure containing one or more gas-holders of variable capacity and the method comprising sustaining a nuclear reaction with fissile material in a molten salt loop of the molten salt nuclear reactor thereby generating off-gas, with the molten salt in the molten salt loop at a pressure that is substantially equal to the ambient pressure outside the containment structure, and storing the generated off-gas in one or more gas-holders of variable capacity at a pressure that is substantially equal to the ambient pressure outside the containment structure.

According to a possible implementation form of the second aspect, the containment structure (40) is a leak-tight sealed containment structure, comprising keeping the containment structure closed throughout the lifespan of the nuclear reactor.

These and other aspects will be apparent from the example(s) and embodiment(s) described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is a diagrammatic representation of an embodiment of a molten salt nuclear reactor with a gas system in a configuration corresponding to the start or early phase of the lifecycle of the nuclear reactor,

FIG. 2 is a diagrammatic representation of the reactor of FIG. 1 in a configuration corresponding to the end or late phase of the lifecycle of the nuclear reactor,

FIG. 3 is a diagrammatic representation of another embodiment of the molten salt nuclear reactor with a gas system in a configuration corresponding to the start or early phase of the lifecycle of the nuclear reactor,

FIG. 4 is a diagrammatic representation of the reactor of FIG. 3 in a configuration corresponding to the end or late phase of the lifecycle of the nuclear reactor,

FIG. 5 is a diagrammatic representation of another embodiment of the molten salt nuclear reactor with a gas system in a configuration corresponding to the start or early phase of the lifecycle of the nuclear reactor,

FIG. 6 is a diagrammatic representation of the reactor of FIG. 5 in a configuration corresponding to the end or late phase of the lifecycle of the nuclear reactor,

FIG. 7 is a diagrammatic representation of another embodiment of the molten salt nuclear reactor with a gas system in a configuration corresponding to the start or early phase of the lifecycle of the nuclear reactor,

FIG. 8 is a diagrammatic representation of another embodiment of the molten salt nuclear reactor with a gas system in a configuration corresponding to the start or early phase of the lifecycle of the nuclear reactor,

FIG. 9 is a diagrammatic representation of another embodiment of the molten salt nuclear reactor with a gas system in a configuration corresponding to the start or early phase of the lifecycle of the nuclear reactor,

FIG. 10 is a diagrammatic representation of another embodiment of the molten salt nuclear reactor with a gas system in a configuration corresponding to the start or early phase of the lifecycle of the nuclear reactor, and

FIG. 11 is a diagrammatic representation of another embodiment of the molten salt nuclear reactor with a gas system in a configuration corresponding to the start or early phase of the lifecycle of the nuclear reactor.

### DETAILED DESCRIPTION

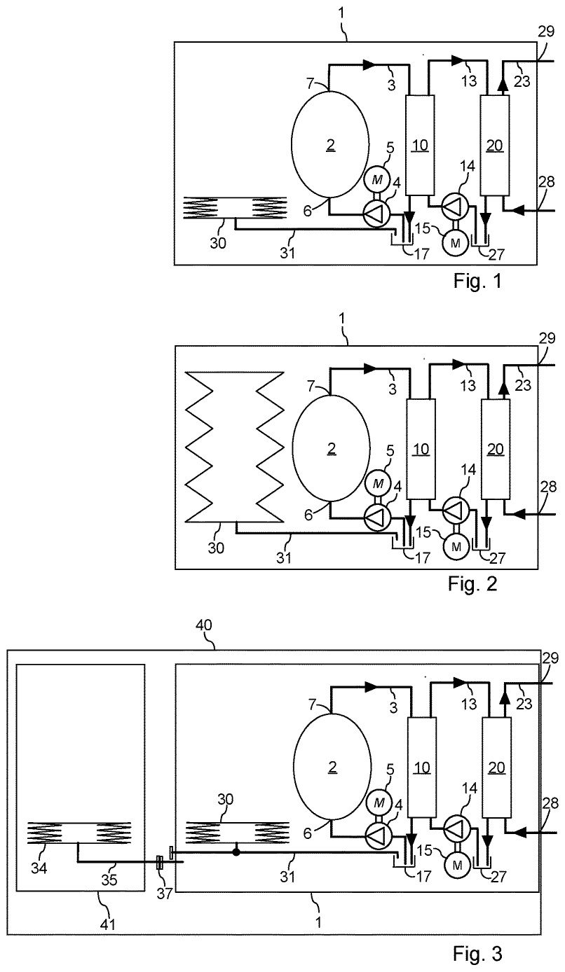

FIG. 1 illustrates a first embodiment of a nuclear reactor 1. The nuclear reactor is arranged in the interior of sealed vessel 1, also referred to as “reactor vessel”. The sealed vessel 1 forms an airtight or leaktight housing in which the components of the nuclear reactor are located. In an embodiment, the reactor vessel 1 is a metal, preferably steel, casing, e.g. a casing with metal or steel walls. In an embodiment, the reactor vessel 1 is provided with two or more layers of airtightness, i.e. double, triple, etc. walled vessel, the third barrier e.g. serving in particular radiation protection (not illustrated in FIG. 1).

The interior of the reactor vessel 1 is filled with a cover gas before the reactor vessel 1 is sealed and the reactor vessel 1 can be divided into a hot area, sometimes referred to as “furnace”, and a cool area, but for reasons of simplicity, these areas have not been separately indicated in FIG. 1. The interior of the vessel 1 contains a nuclear reactor core 2, and a fuel salt loop 3, for transporting heat away from the nuclear reactor core 2 by circulating the fuel salt.

The fuel salt is a fluoride or chloride salt. For these types of salt to be molten, the operating temperature needs typically to be above 500 °C and will typically be between 500 and 800 °C. The fuel salt not only serves to remove heat from the reactor but has additional functions, e.g. acting as moderator and containing the nuclear fuel. The fuel salt comprises fissile components, preferably comprising enriched lithium 7 fluoride, thorium tetrafluoride, uranium tetrafluoride, uranium trifluoride and/or plutonium trifluoride 7LiF-ThF4-UF4-UF3-PuF3 salt.

During the operation of the nuclear reactor, a sustained nuclear-controlled chain reaction takes place in the nuclear reactor core 2.

The fuel salt loop 3 comprises a fuel salt pump 4 for circulating the fuel salt in the fuel salt loop 3. The fuel salt pump 4 is driven by a fuel salt motor 5, which is preferably an electric drive motor provided with a motor drive for adjusting the speed of the electric motor 5. Heaters (not shown), e.g. electric heaters are provided for the fuel salt loop 3 and any other heat exchange loop that contains a heat exchange medium that is solid at normal room or environment temperatures, to allow the medium to warm up to the liquid phase so that the heating medium can be pumped.

The fuel salt loop 3 extends through the nuclear reactor core 2, and accordingly, the nuclear reactor core 2 is provided with a fuel salt inlet 6 and a fuel salt outlet 7 that connect the portion of the fuel salt loop 3 that extends through the nuclear reactor core 2. The fuel salt loop 3 passes through a first heat exchanger 10 for exchanging heat with a primary cooling medium and through fuel salt tank 17 which forms the lowest part of the fuel salt loop 3. The fuel salt pump 4 pumps the fuel salt up from the fuel salt tank 17. The fuel salt loop 3 is not pressurized, i.e. the fuel salt is operated at a first substantially atmospheric pressure.

The nuclear reactor comprises a primary heat exchange loop 13 that is arranged inside the reactor vessel 1. The primary heat exchange loop passes through the first heat exchanger 10 and exchanges heat with an internal as well as external heat exchange medium in a second heat exchanger 20. The primary heat exchange loop 13 comprises a primary pump 14 for circulating the primary heat exchange medium in the primary heat exchange loop 13. The primary pump 14 is driven by a primary motor 15, which is preferably an electric motor. The primary heat exchange loop 13 passes through a primary heat exchange medium tank 27 which preferably forms the lowest part of the primary heat exchange loop 13. The primary loop 13 is not pressurized, i.e. the primary heat exchange medium is operated at a second substantially atmospheric pressure. In an embodiment, the primary heat exchange medium is a (molten) fluoride or chloride salt but it could also be another type of salt, or another type of suitable liquid, gas, or vapor. The function of the primary heat exchange medium is to transfer heat from the fuel salt to an internal as well as external heat exchange medium.

A conduit 23 for removing heat from the interior of the reactor vessel 1 is arranged in the interior of the reactor vessel 1. An internal as well as external heat exchange medium flows through the conduit 23. In an embodiment, the internal as well as external heat exchange medium is a molten nitrate salt, but it could also be another type of salt, or another type of suitable liquid, gas, or vapor. The internal as well as external heat exchange medium is pumped through the internal as well as external heat exchange medium conduit 23, which passes through the second heat exchanger 20 to remove heat from the primary heat exchange medium and convey this heat to an external consumer of heat (not shown). The conduit 23 fluidically connects an inlet 28 with an outlet 29. Both the inlet 28 and the outlet 29 penetrate the walls of the reactor vessel 1 for connecting to the exterior consumer of heat.

A suitable cover gas is arranged above the fuel salt I fule salt loop 3 before starting up the nuclear reactor. A nuclear reactor produces roughly 1 MWd (Megawatt-day) of thermal energy per gram of fissile material that is fissioned. Roughly 12% of the molar fraction of fission products end up as stable xenon isotopes and less than 1% as krypton. As an example from this, a 100 MWth (megawatt thermal) nuclear reactor that operates for 5 years will produce roughly 24 kg of xenon gas, taking up approximately four cubic meters at atmospheric pressure and room temperature or approximately fourteen cubic meters at atmospheric pressure and 650 °C. Since xenon gas represents most of the off-gas, a capacity of approximately four cubic meters is required to store the off-gas at atmospheric pressure and room temperature or approximately fourteen cubic meters at atmospheric pressure and at or near the operating temperature of a molten salt reactor, in this specific example. The nuclear reactor will typically operate from start-up until the nuclear fuel is depleted to a given level or the reactor has reached its operating lifespan and subsequently the nuclear reactor is decommissioned. The off-gas amount that will be produced for a given fuel burnup can be accurately determined in advance.

In the nuclear reactor according to the present embodiment, the off-gas is stored in a primary low-pressure gas-holder 30 of variable capacity configured for holding gas originating from the fuel salt loop 3, i.e. the low-pressure variable gas-holder 30 is dimensioned to take into account not only the off-gas production but also the expansion from heating the system to operating temperature and the interplay between different expanding volumes inside the reactor vessel 1. Accordingly, the off-gas is stored in the primary low-pressure gas-holder 30 of variable capacity at low pressure inside the reactor vessel and can stay inside the reactor vessel until the nuclear reactor is decommissioned. Furthermore, the nuclear reactor and gas-holder can be moved after the shutdown of the nuclear reactor, at its operational period, to a location outside the containment vessel, and left to allow the activity of the nuclear reactor, gas-holder, and its content to decrease before decommissioning. Consequently, there is no need to remove off-gas from the nuclear reactor during the lifespan of the nuclear reactor, its cool-down period, or before its final decommissioning, thereby significantly reducing the risk of contaminating the environment with radioactive off-gas.

The gas system comprises a first relief conduit 31 that fluidically connects a space above the fuel salt in the fuel salt loop 3 to a low-pressure gas-holder 30 of variable capacity.

In the present embodiment, the first relief conduit 31 is shown to connect to the molten salt tank 17, but it should be understood that the first relief conduit 31 could connect at any position to the fuel salt loop 3 that provides access to the cover gas and off-gas.

FIG. 1 shows the configuration of the nuclear reactor at the start of its lifecycle, with the fuel salt containing fissile material that has not yet been fissioned and the primary low-pressure gas-holder 30 of variable capacity not yet having received any off-gas. In the present embodiment, the primary gas-holder 30 of variable capacity has a first internal volume when the molten salt nuclear reactor is started up for the first time and has a second internal volume when the molten salt nuclear reactor is (to be) decommissioned, the second internal volume being larger than the first internal volume to accommodate for the off-gas produced during while fissioning the fissile material. This is illustrated by FIG. 2, which shows the primary gas-holder 30 of variable capacity in an expanded state with a larger volume and filled with off-gas produced during the lifespan of the fissile material. In this embodiment, the nuclear reactor and the primary gas-holder 30 of variable capacity are configured such that the primary gas-holder 30 of variable capacity is sufficiently large to contain the off-gas produced during the lifespan of the nuclear reactor at low pressure.

The lifespan of the nuclear reactor is in an embodiment determined by the lifespan of the nuclear fuel, i.e. due to the depletion of the nuclear fuel. The lifespan of the nuclear reactor can also be determined by other factors, e.g. wear and tear and radiation damage of the components of the nuclear reactor, requiring the nuclear reactor to be decommissioned before the nuclear fuel has been depleted. Alternatively, the primary gas-holder 30 of variable capacity is insufficient for holding all of the off-gases that are produced by the nuclear fuel over the lifespan of the nuclear reactor and in this embodiment, it is required to replace the primary gas-holder 30 of variable capacity once or several times during the lifespan of the nuclear reactor. In this embodiment, it is assumed that the nuclear reactor, in particular, the reactor vessel 1 is kept closed or in a closed containment structure throughout the lifespan of the nuclear reactor. Thus, in this embodiment the reactor vessel 1, is a leak-tight or hermetically sealed containment structure, that is kept closed throughout the lifespan of the nuclear reactor. Accordingly, throughout the lifespan of the nuclear reactor, there is no replenishment of nuclear fuel (fissile material), and the off-gas produced is stored at low pressure in the reactor vessel 1. Allowing the reactor vessel 1 to be leak-tight sealed and closed during the lifespan of the nuclear reactor significantly reduces the risk of contamination of radioactive material to the environment of the nuclear reactor and the risk of undesirable elements from the atmosphere into the nuclear reactor.

The primary gas-holder 30 of variable capacity comprises in the present embodiment flexible walls for allowing expansion of the primary gas-holder 30 of variable capacity, without significant increase of the pressure in the primary gas-holder of variable capacity 30. Thus, the primary gas-holder 30 of variable capacity according to the present embodiment is constructed similarly to bellows, i.e. comprising a flexible corrugated element. This flexible corrugated element is in an embodiment made from metal such as stainless steel or high nickel alloy, an organic polymer with a metal foil liner, or of an organic polymer, or a combination thereof.

The gas system is in the present embodiment a closed system that fluidically only connects to the fuel salt loop 3.

In an embodiment, the primary gas-holder 30 of variable capacity is equipped with burst disks or safety relief valves in case of over-or under-pressurization, e.g. to ensure that systems fail in a predictable manner so that the off-gas is channeled to the backup gas-holder, filter, and or scrubber.

The primary low-pressure gas-holder 30 of variable capacity is arranged in the reactor vessel 1 with the aim and pressure around the primary low-pressure gas-holder 30 of variable capacity preferably being substantially equal or slightly below ambient pressure outside the containment structure 1. Typically, the pressure in the gas system is slightly above the pressure surrounding the primary low-pressure gas-holder 30 of variable capacity. Consequently, there is no need for a constant cover gas supply and thereby no source of contaminants like oxygen and moisture from a cover gas supply. The system can be completely purged with cover gas before closing up the system and starting the reactor, thus eliminating the ingress of oxygen and moisture, since the system is completely sealed off from the outside. Furthermore, this allows for the salt containing structure not to be a pressure vessel instead allowing the pressure to be equalized with a surrounding containment structure that does not have to be at the operating pressure of the salt. This system is thus simpler and safer than the known systems. It also allows for using argon as a cover gas instead of helium, since the neutron-activated argon can be contained in the system completely and can be left to decay after shutdown of the reactor and before opening up the system.

The reactor, salts, and off-gas can be left for long-term storage and disposal, without the risks associated with a pressurized system. The gas system allows for removal and reuse of the salt, while the off-gas and reactor vessel can be left for storage (to allow for decay of radioactive material) and later disposal, without the risks associated with a pressurized system.

Cover gas and off-gas removal and or purging can be done remotely, e.g. to facilitate the moving of still highly radioactive gas.

Alternatively, if the low-pressure gas-holder 30 of variable capacity is suspected to be contaminated or has a limited lifetime left, its placement can be such that the low-pressure gas-holder 30 of variable capacity can be swapped or repeatedly swapped during regular reactor operation or maintenance procedures. Possible contamination is for example from volatile fission products, and from decay of noble gasses to metals.

The primary low-pressure gas-holder 30 of variable capacity is shown as a single entity in FIGS. 1 and 2. However, it should be understood that the primary low-pressure gas-holder 30 of variable capacity can be formed by a plurality of gas-holder units that are each connected to the fuel salt loop or other molten salts contained in the nuclear reactor respectively.

FIG. 3 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 1, except that the first relief conduit 31 has a branch that extends to the exterior of the reactor vessel 1 and is provided with a coupling and valve or other means to close the part of the first relief conduit that extends to the exterior of the reactor vessel, illustrated by a flange. The coupling allows the first relief conduit 31 to be selectively fluidly connected to another entity.

In this embodiment, the reactor vessel 1 is arranged in a containment structure 40. The containment structure 40 is preferably a leak-tight or hermetically sealed vessel that remains closed throughout the lifecycle of the nuclear reactor. Thus, at the start of the lifecycle of the nuclear reactor the nuclear reactor is filled with all the required material, such as the salt(s), cover gas, and the fissile material. at the end of the lifecycle of the nuclear reactor, the complete nuclear reactor is decommissioned and only the salt(s) are reused in another nuclear reactor.

A gas-holder containment structure 41 containing a secondary low-pressure gas-holder 34 of variable capacity is arranged in the containment structure 40. The secondary low-pressure gas-holder 34 of variable capacity is fluidically connected to the interior of the reactor vessel 1 by a second relief conduit 35. The second relief conduit 35 is provided with a coupling and valve or other means to close the part of the first relief conduit that extends to the exterior of the reactor vessel, illustrated by a flange 37. The coupling allows the second relief conduit 35 to be selectively fluidly connected to another entity, e.g. for swapping the gas-holder containment structure 41.

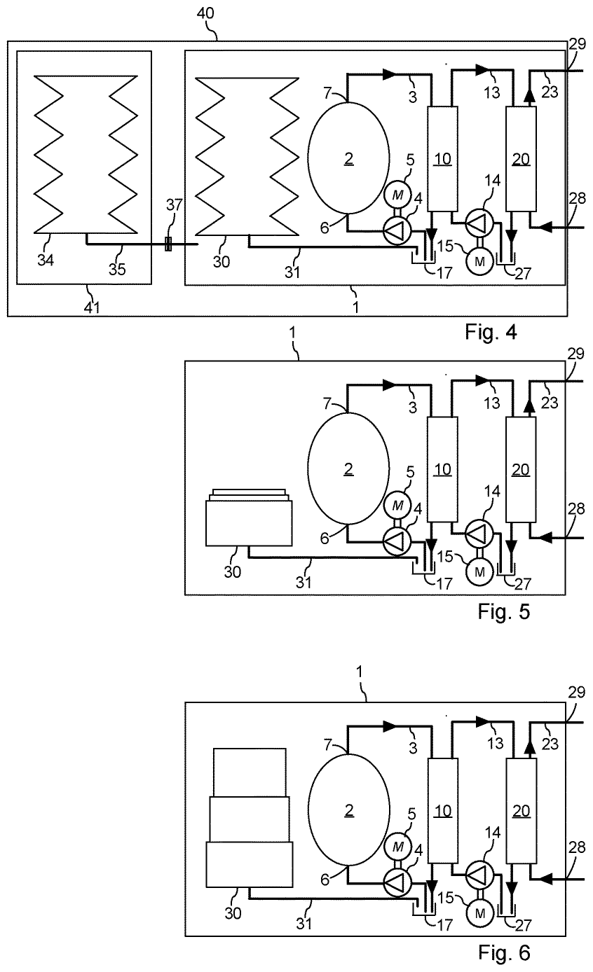

The secondary gas-holder 34 of variable capacity is configured to receive cover gas from the reactor vessel 1. In FIG. 3 both the primary low-pressure gas-holder 30 of variable capacity and secondary low-pressure gas-holder 34 of variable capacity are illustrated in their retracted configuration, i.e. having the lowest volume. The cover gas in the reactor vessel 1 is, during operation of the nuclear reactor, likely relatively high whilst the temperature in the gas-holder containment structure 41 is, during operation of the nuclear reactor, likely relatively low e.g. room temperature. Thus, the hot cover gas received from the interior of the reactor vessel 1 will cool down in the secondary low-pressure gas-holder 34 of variable capacity and take up less space. FIG. 4 illustrates the configuration of the nuclear reactor of the embodiment of FIG. 3 towards the end of its lifecycle, with the primary low-pressure gas-holder 30 of variable capacity in an expanded configuration (having a larger volume) and holding the off-gas generated by the operation of the nuclear reactor and the secondary low-pressure gas-holder 34 of variable capacity also in an expanded configuration holding gas received from the interior of the reactor vessel 1.

FIG. 5 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 1, except that the primary low-pressure gas-holder 30 of variable capacity is of a telescopic type, i.e. arranged as a telescopic cylinder. In FIG. 5 the primary low-pressure gas-holder 30 of variable capacity is illustrated in its retracted configuration, i.e. having the lowest volume, the conflagration that corresponds to the configuration of the nuclear reactor at the start of the lifecycle of the nuclear reactor. FIG. 6 illustrates the configuration of the nuclear reactor of the embodiment of FIG. 3 towards the end of its lifecycle, with the primary low-pressure gas-holder 30 of variable capacity in an expanded configuration (having a larger volume) and holding the off-gas generated by the operation of the nuclear reactor.

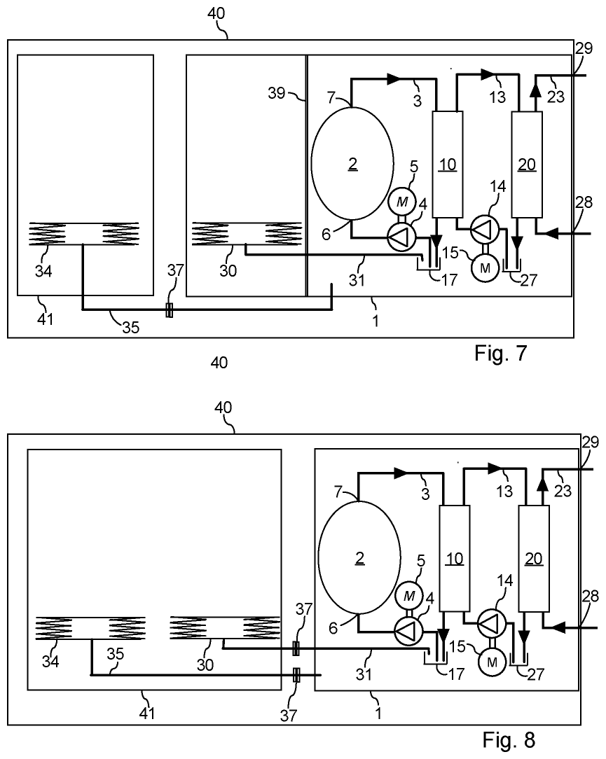

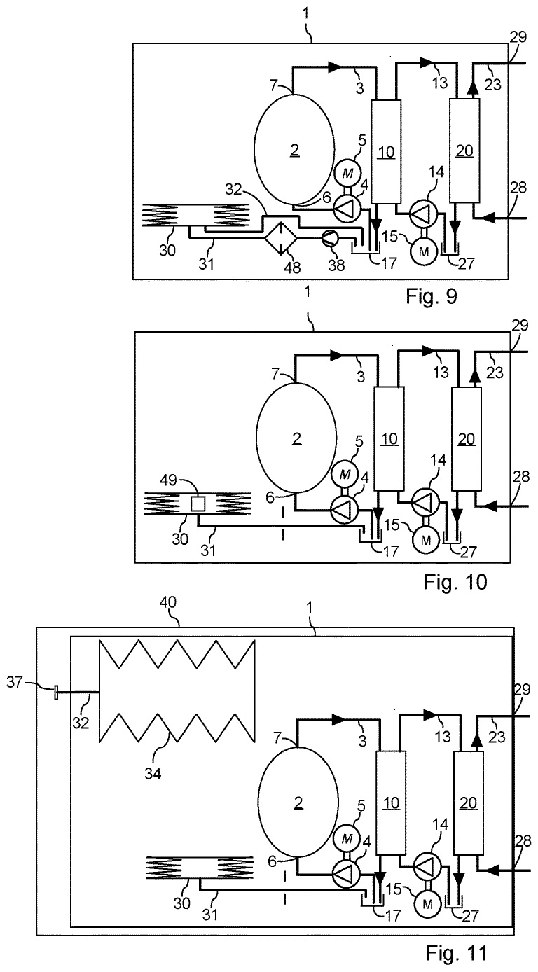

FIG. 7 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 3, except that the interior of the reactor vessel 1 is divided into a hot area and the cold area by a separation wall 39. The primary low-pressure gas-holder 30 of variable capacity is arranged in the cold zone and the first relief conduit 31 extends from the hot zone to the cold zone.

Thus, with the reactor vessel 1 or containment structure 40 is provided with both hot and cold zones then this can be taken advantage of by hot expanding gas is expanding into a gas-holder in a colder and cooled region, contracting the gas such that it takes up a smaller amount of space.

FIG. 8 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 3, except that the primary gas-holder 30 of variable capacity is arranged in the gas-holder containment structure 41. The secondary gas-holder 34 of variable capacity is connected to the interior of the reactor vessel 1 by the second relief conduit 35. The secondary gas-holder 34 is in its retracted state at the start of the operation of the nuclear reactor to allow expansion of gas in the reactor vessel 1 due to e.g. temperature increase. In this embodiment, the first and second gas-holders 30,34 are in a separate box/containment structure 41 and can be disconnected and reused when the reactor is replaced. The gas in the first and second gas-holders 30,34 can be siphoned off before disconnecting the reactor with the extra flange 37.

FIG. 90 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 1, except that a filter 48 is arranged in the first relief conduit 48 for removing e.g. volatile compounds, reactive species, tritium, which could potentially migrate through the gas-holder wall material or particulate matter. Instead of a filter 48 a trap, or scrubber can be used. Further, in this embodiment, the gas-holder 30 of variable capacity is connected to the fuel salt loop 3 by a return conduit 32. A blower 38 (or other means for forced recirculation of the off-gas through the gas-holder 30 of variable capacity (and through the filter 48) is also provided for increased purification of the off-gas by the action of the filter 48.

FIG. 10 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 1, except that an absorber 49 is arranged in the low-pressure gas-holder 30 for removing e.g. volatile compounds, reactive species, tritium, which could potentially migrate through the gas-holder wall material or particulate matter.

FIG. 12 is a diagrammatic representation of another embodiment of the nuclear reactor. In this embodiment, structures, and features that are the same or similar to corresponding structures and features previously described or shown herein are denoted by the same reference numeral as previously used for simplicity. In this embodiment, the reactor vessel 1 and the components therein are essentially identical to the embodiment of FIG. 3, except that second gas-holder 34 of variable capacity is arranged inside the reactor vessel 1 and in its extended state at the start of the operation of the nuclear reactor, with a relief conduit 32 connecting the interior of the second gas-holder 34 of variable capacity to the space in the containment structure 40 that surrounds the reactor vessel 1. Accordingly, the second gas-holder 34 of variable capacity will retract during the operation of the nuclear reactor whilst the first gas-holder 30 of variable capacity will expand, reducing increase of pressure in the reactor vessel 1 during operation of the nuclear reactor.

In an embodiment, the reactor vessel 1 is provided with a second gas-holder 34 of variable capacity that allows for the volume to expand and equalize its pressure with the cover gas inside the containment structure 40, and each salt loop 3,30 is provided with a gas-holder 30 inside the reactor vessel 1 that allows for the volume to expand and equalize its pressure with the cover gas inside the reactor vessel 1.

In an embodiment, wherein the gas-holders of variable capacity are nested in each other to provide additional barriers to radionuclide release.

Gas-holders 30,34 will expand, and neglecting the weight of the gas-holder material and/or stretching of the gas-holder material is going to equalize the internal with the external pressure so that the pressure boundary with be the outer containment vessel, and any gas generation in the bladder will not lead to a differential pressure difference between the inside and outside of the bladder but rather a pressure equilibrium where the internal pressure of the containment vessel 40 will increase alongside the gas-holder pressure and thus the containment structure 40 will be the pressure bearing structure. The system initially can be held at or above or below ambient pressure. If the system is held after purging at below ambient pressure, then there will be room for gas generation and temperature increase without resulting in larger than ambient pressures inside the vessel. In one embodiment, after purging and before sealing the pressure bound the whole system is brought to sub-atmospheric pressure so that the system would leak inwards in case of a rupture of the pressure boundary, limiting the risk of a radionuclide release.

In an embodiment the reactor vessel 1 is located inside containment structure 40, the reactor vessel 1 is provided with a gas-holder 30 of variable capacity that allows for its volume to expand and equalize its pressure with cover gas inside the containment structure. Each salt loop is provided with a gas-holder 30 inside the reactor vessel 1 that allows for the volume to expand and equalize its pressure with the cover gas inside the reactor vessel 1. Accordingly, there are several barriers to off-gas release: first the gas-holder 30 connected to the salt loop 3, then the reactor vessel gas-holder 34, and finally the containment structure 40 and only the last barrier is potentially a pressure barrier. Furthermore, in this way neither the salt loops 3,13 and tanks 17,27 nor the reactor vessel 1 needs to be a pressure vessel, lowering their complexity and cost.

It is noted that for all the embodiments above the gas-holder 30, 34 of variable capacity can be arranged in a horizontal configuration as shown for the second gas-holder 34 in FIG. 12 to avoid the weight of the components of the gas-holder 30, 34 to have an effect on the pressure of the gas inside the gas-holder 30, 34.

It is noted that for all the embodiments above the gas-holder 30, 34 of variable capacity can be arranged upside down from the configuration shown in the figures to cause the weight of the components of the gas-holder exert a slight negative pressure on the inside of the gas holder when compared to the surroundings pressure.

In an embodiment, the nuclear reactor comprises a liquid moderator circuit or loop with a space above the liquid moderator with cover and/or off-gas being fluidically connected to a gas-holder of variable capacity.

For all of the embodiments above, it is noted that the nuclear reactor may comprise blanket salt in a blanket salt loop, fission product scrubber salt in a fission product scrubber salt loop, coolant salt in one or more additional coolant salt loops, and that each of these salt systems can be provided with its own gas-holder of variable capacity configured for holding gas originating from the molten salt loop concerned. These embodiments are not shown in the plots for simplicity.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure.

1. A molten salt nuclear reactor comprising:
a vessel (1,40) containing:
at least one molten salt loop (3,13), and
a gas system for receiving gas originating from the at least one molten salt loop (3,13),
the gas system comprising at least one gas container (30,34) configured for holding gas originating from the molten salt loop (3,13),
wherein
the vessel (1,40) is a closed and leak-tight vessel, and
the gas container (30,34) is a gas-holder of variable capacity.

2. The molten salt nuclear reactor according to claim 1, wherein:
the at least one gas-holder (30, 34) of variable capacity is a low-pressure gas-holder of variable capacity, and/or
the pressure around the at least one gas-holder (30,34) of variable capacity is substantially equal to or slightly below ambient pressure outside the closed and leak-tight vessel (1,40),
and/or
the pressure in the gas system is equal to or slightly above the pressure surrounding the at least one gas-holder (30,34) of variable capacity.

3. The molten salt nuclear reactor according to claim 1, wherein the at least one molten salt loop (3) comprises fissile material that generates off-gas, wherein the at least one gas-holder (30) of variable capacity is dimensioned to hold the off-gas generated by the fissile material, preferably dimensioned to hold the off-gas generated during the lifespan of the fissile material or during the lifespan of the molten salt nuclear reactor.

4. The molten salt nuclear reactor according to claim 1, wherein the gas system is configured to contain a cover gas when the molten salt nuclear reactor is started up for the first time.

5. The molten salt nuclear reactor according to claim 1, wherein the at least one gas-holder (30,34) of variable capacity is configured to have a first internal volume when the molten salt nuclear reactor is started up for the first time and a second internal volume when the molten salt nuclear reactor is decommissioned, the second internal volume being larger than the first internal volume.

6. The molten salt nuclear reactor according to claim 5, wherein the second internal volume is sufficient for accommodating the off-gas generated during operation of the nuclear reactor and at the temperature caused by operation of the nuclear reactor, at a pressure that is slightly higher than the pressure surrounding the at least one gas-holder (30,40) of variable capacity.

7. The molten salt nuclear reactor according to claim 5, wherein the difference between the second internal volume and the first internal volume is sufficient for accommodating the off-gas generated in the period between the initial start-up of the molten salt nuclear reactor and decommissioning of the molten salt nuclear reactor, at a pressure that is at most equal or slightly higher than the pressure surrounding the at least one gas-holder (30,40) of variable capacity.

8. The molten salt nuclear reactor according to claim 1, wherein the gas system is a closed system that fluidically only connects to the at least one molten salt loop (3,13).

9. The molten salt nuclear reactor according to claim 1, wherein the at least one gas-holder (30,34) of variable capacity comprises one or more movable pistons and/or telescopically parts and/or comprises flexible walls and/or a bladder for allowing expansion of the at least one gas-holder (30, 34) of variable capacity, preferably without significant increase of the pressure in the gas-holder (30,34) of variable capacity.

10. The molten salt nuclear reactor according to claim 1, comprising a containment structure (40) containing:
the reactor vessel (1) containing the at least one gas-holder (30,34) of variable capacity forming a primary gas-holder (30) of variable capacity, and
a gas-holder containment structure (41) containing at least one secondary gas-holder (34) of variable capacity, the at least one secondary gas-holder (34) of variable capacity being fluidically connected to the interior of the reactor vessel (1) and preferably being a low-pressure gas-holder.

11. The molten salt nuclear reactor according to claim 10, wherein the secondary gas-holder (34) of variable capacity is configured to receive gas from the reactor vessel (1), the temperature in the gas-holder containment structure (41) preferably being lower than the temperature in the reactor vessel, thereby allowing the gas received from the reactor to cool down and take up less space.

12. The molten salt nuclear reactor according to claim 10, wherein the reactor vessel (1) is divided into a hot and a cold area, and wherein the at least one primary gas-holder (30) of variable capacity is arranged in the hot area and the secondary gas-holder (34) of variable capacity is arranged in the cold area.

13. The molten salt nuclear reactor according to claim 10, wherein the reactor vessel (1) is provided with a gas-holder (34) of variable capacity that allows for its volume to expand and equalize its pressure with the pressure of the cover gas inside the containment structure (40) and each salt loop (3, 30) is provided with a gas-holder (30) inside the reactor vessel (1) that allows for its volume to expand and equalize its pressure with the pressure of the cover gas inside the reactor vessel (1).

14. The molten salt nuclear reactor according to claim 10, wherein the at least one gas-holder (30,34) of variable capacity is nested inside another at least one gas-holder (30,34) of variable capacity to provide additional barriers to radionuclide release.

15. The molten salt nuclear reactor according to claim 1, comprising a filter (48), trap, or scrubber, for removing e.g. volatile compounds, reactive species, salt mist, salt vapor, tritium, which could potentially migrate through the gas-holder wall material, impurities, or particulate matter, filter preferably being arranged in a conduit between the at least one gas-holder (30) of variable capacity and the at least one molten salt loop (3,13).

16. The molten salt nuclear reactor according to claim 1, wherein the at least one gas-holder (30,34) of variable capacity contains an absorber (49) to react with or bind species of off-gasses.

17. The molten salt nuclear reactor according to claim 1, comprising a return conduit (32) between the at least one gas-holder (30, 34) of variable capacity and the at least one molten salt loop (3), and preferably a blower (38) for recirculating the off-gas through the at least one gas-holder (30, 34) of variable capacity, the blower (38) preferably being arranged in the feed conduit (31) or in the return conduit (32).

18. A method of operating a molten salt nuclear reactor arranged in a containment structure (40), the containment structure (40) containing one or more gas containers (34), and the method comprising sustaining a nuclear reaction with fissile material in a molten salt loop (3) of the molten salt nuclear reactor thereby generating off-gas, with the molten salt in the molten salt loop at a pressure that is substantially equal to the ambient pressure outside the containment structure (40), wherein the one or more gas containers (34) are gas-holders of variable capacity, and storing the generated off-gas in the one or more gas-holders (34) of variable capacity at a pressure that is substantially equal to the ambient pressure outside the containment structure (40).

19. The method according to claim 18, wherein the containment structure (40) is a leaktight containment structure, and wherein the method comprises keeping the containment structure (40) closed throughout the lifespan of the nuclear reactor.
